(19) United States
(12) Patent Application Publication
(10) Pub. No.: US 2017/0163614 A1
(43) Pub. Date: Jun. 8, 2017

(54) Method, a Device, a Dedicated Device and a System for Encrypting Communication

(71) Applicant: XXLSec Oy, Espoo (FI)

(72) Inventors: Pasi Patama, Helsinki (FI); Jouni Viitanen, Tuusula (FI); Arimo Koivisto, Helsinki (FI); Mikko Nikkanen, Tampere (FI); Simo Salminen, Helsinki (FI)

(21) Appl. No.: 14/958,367

(22) Filed: Dec. 3, 2015

(51) Int. Cl. H04L 29/06

(52) U.S. Cl. CPC H04L 63/0457; H04L 63/0442; H04L 63/0876; H04L 63/0492

(57) ABSTRACT

The application relates to a method for encrypting communication in a communication network, a communication device, a dedicated device and a system for encrypting communication in a communication network.

According to an embodiment a method for encrypting a communication data of a communication device comprises establishing a connection to a dedicated device and transmitting the communication data via the connection to the dedicated device. The method further comprises encrypting the communication data by executing program code as stored in a memory of the dedicated device by a processor of the dedicated device.

### TECHNICAL FIELD

The application concerns a method for encrypting communication in a communication network, a communication device, a dedicated device and a system for encrypting communication in a communication network.

### BACKGROUND

Network entities communicate via a communication network. Two or more network entities may establish a communication link between each other. During a call connection speech detected by a microphone is converted to digital audio data. Digital audio data is encrypted, before transmission to air interface. Encryption may be implemented using encryption keys, by mixing audio data using key generator. The original audio data cannot be recognized from the encrypted data, which is transmitted. Encrypted audio data provides confidentiality. At a receiving end a corresponding decryption key(s) is used for decrypting the digital data to its original form, before the digital data is converted to analog form and outputted as voice.

Before transmission each digital bit stream may be cryptographically converted by encryption algorithm into different form of cipher bit stream. The cipher bit stream does not correspond to the original digital bit stream. Cipher bit stream is deciphered in order to receive data and reproduce it according to the original bit stream. Enciphering may be implemented between a terminal and a base station in a communication network.

Keys or algorithms for encryption may be stored in Home Location Register (HLR) of a mobile communication network. In Global System for Mobile Communications (GSM) ciphering is a single logical channel between a terminal, Mobile Station (MS) and a Base Station (BS).

In General Packet Radio Service (GPRS) network security is based on secrecy of secret keys. The keys are stored into a Subscriber Identification Module (SIM) card of a terminal and into a Home Location Register (HLR) of a network. The secret key is not known by the subscriber. Data and signalling are ciphered using a secret encryption algorithm. Ciphering functions are located at a terminal comprising a SIM and at Service GPRS Support Node (SGSN).

Communication may be established over Internet Protocol (IP) via internet or intranet(s). A terminal receives an IP address from operator's addressing space. The address is a public IP address, which is used for packet transmission between Internet nodes and the Gateway GPRS Support node (GGSN), and for mapping transmitted data packet to a correct address(es). In order to provide secure communication a dedicated link or secured tunnel utilizing a security protocol may be arranged.

Most data encryption solutions have been implemented, at least partly, inside programmable communication terminal devices, like mobile terminals, mobile phones, smart phones. Encryption functionality relies on encryption libraries provided by a manufacturer of the device and on firm operating systems (OS) of the device. For a user this causes lack of visibility. Security may be provided by obscurity. There is no way to follow up, trace or double-check implementation for security issues.

### SUMMARY

It is an object of the application to provide a secure data encryption for communication network. The security or used encryption may be double-checked. This may enable ensuring currently used way, means and validity of encryption.

According to embodiments data security for a data transmitted in a communication network is available for a communication device. A dedicated hardware is provided for executing an encryption algorithm or program code for such. The dedicated hardware may be an encryption device placed out of telecommunication or other network domain, and accessible to a network terminal. Encryption algorithm is based on a source code. An executable binary program code is converted solely from the source code. The source code lacks any binary elements. System, entities and/or functionality lacks any binary module or -part linking into program code.

According to an aspect of the invention a method for encrypting a communication data of a communication device comprises establishing a connection to a dedicated device, transmitting the communication data via the connection to the dedicated device, encrypting the communication data by executing program code stored in a memory of the dedicated device by a processor of the dedicated device.

According to an aspect of the invention a method for decrypting a communication data of a communication device comprises receiving encrypted communication data, establishing a connection to a dedicated device, transmitting the encrypted communication data via the connection to the dedicated device, and decrypting the encrypted communication data by executing program code stored in a memory of the dedicated device by a processor of the dedicated device.

According to an another aspect of the invention a communication device for a communication network comprises a transceiver arranged to transmit communication data to the communication network, an interface arranged to establish a connection to a dedicated device in order to enable transmission of the communication data via the connection to/from the dedicated device, wherein the dedicated device comprises a processor and a memory for storing a program code executable by the processor, and wherein the program code, when executed by the processor, is arranged to encrypt the communication data.

According to an another aspect of the invention a communication device for a communication network comprises a transceiver arranged to receive encrypted communication data from the network, an interface arranged to establish a connection to a dedicated device in order to enable transmission of the encrypted communication data via the connection to/from the dedicated device, wherein the dedicated device comprises a processor and a memory for storing a program code executable by the processor, and wherein the program code, when executed by the processor, is arranged to decrypt the encrypted communication data.

According to yet another aspect of the invention a dedicated device comprises an interface arranged to establish a connection to a communication device of a network, a processor, a program code, the program code, when executed by the processor arranged to encrypt/decrypt a communication payload received via the interface.

In an aspect of the invention a system for arranging communication between communication devices in communication network comprises two communication devices each comprising a transceiver arranged to transmit encrypted data to and receive encrypted data from the communication network, each communication device is connectable to a dedicated device in order to enable transmission of decrypted/encrypted data between the communication device and the dedicated device, wherein the dedicated device is arranged to encrypt/decrypt the decrypted/encrypted data.

### BRIEF DESCRIPTION OF THE DRAWINGS

In the following embodiments are described in more detail with the accompanying figures, of which

FIG. 1 illustrates a system according to an embodiment.

FIG. 2 illustrates an apparatus according to an embodiment.

FIG. 3 illustrates a system according to an embodiment.

FIG. 4a illustrates a method according to an embodiment.

FIG. 4b illustrates a method according to an embodiment.

### DETAILED DESCRIPTION

Embodiments provide truly secure data encryption for communication network(s). A terminal having access to a dedicated device according to embodiments may utilize data encryption according to embodiments. The dedicated device according to embodiments is located out of domains using it, like telecommunication domain or terminal domain. Secure data encryption is provided by a source code only software and a dedicated device for executing the software. The software comprises executable code converted solely from a source code. The source code comprises no binary components or elements. No binary components or links to such are present. The executable code is based solely on the source code. This enables providing encrypted data for transmission over network without sharing program address space or storage with the transmitting terminal or network elements.

Currently operating systems of mobile terminals, like smartphones, are delivered in executable binary format. The user gains no knowledge of source code used to compile deliverables inside mobile terminals. Even open operating systems, like Android, comprise binary components linked into built processes inside terminals. The source code is partly visible and partly invisible due to binary blocks linked in provided final operating system deliverable. Invisibility of source code has effect of preventing access to source code. It is not possible to evaluate how a platform is handling data processing elements providing security. Implementation built in a source code cannot be accessed. Binary elements inside mobile operating systems pose an increased risk and unverifiable element for any mathematically composed security algorithm. For example, encryption algorithm validity, key generation randomness, exfiltration, weakening or impairment of security cannot be double-checked.

One issue causing risks is implementing encryption in a domain, where unknown software is also run. This may open possibilities for a software to point to a memory space comprising items, like instructions or keys, for implementing encryption. Such risks are removed by a dedicated encryption system according to aspects of the invention, which is provided in an external interface, out of the used domain(s). The dedicated system cannot be pointed from memory space of a terminal, for example. Encryption for data is provided without sharing program address space and storage with the mobile terminal or network elements.

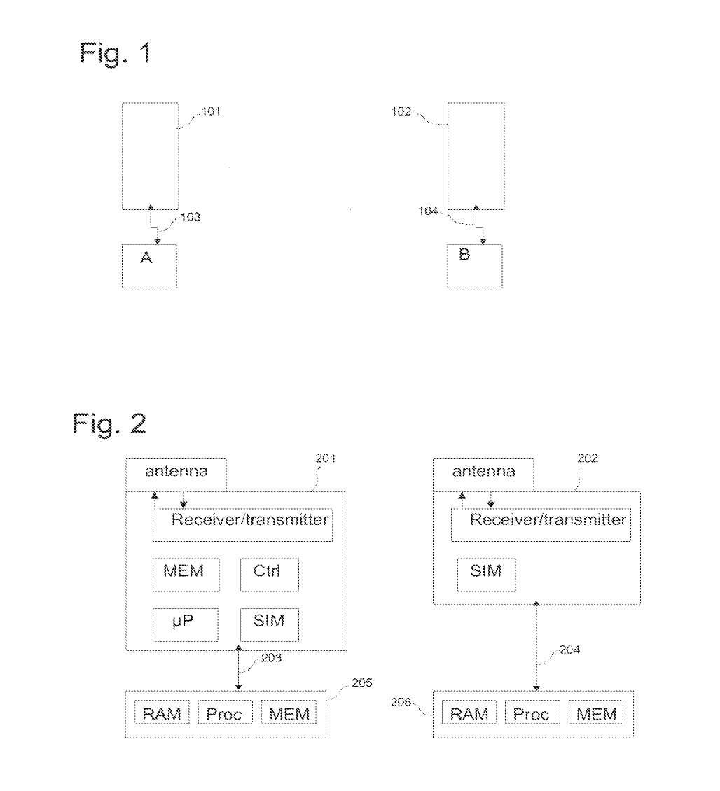

FIG. 1 illustrates a system for providing speech encryption according to an embodiment. FIG. 1 shows communication devices 101, 102 of a network. Communication device 101 comprises access to a dedicated device A. Link 103 between the communication device 101 and the dedicated device A may be wired or wireless link, for example an optical link. The communication device 101 and the dedicated device A are able to transmit data packets via the link 103. Speech data captured by a microphone of the communication device 101 is transmitted to the dedicated device A via the communication link 103. The speech data is processed in the dedicated device A. In addition to processing, for example A/D-converting and encoding speech data, the dedicated device is arranged to encrypt communication, before transmission to a communication network via the communication device 101. Dedicated device A is arranged to encrypt a payload of communication to be transmitted. The encryption at the dedicated device A is accomplished before the speech data is transmitted to a communication network via the communication device 101.

Data transmitted in a network comprises protected payload, like audio signal(s). Transmitted data may comprise data stream or data packet(s), for example an internet protocol (IP) packet. IP packet comprises a header, which contains information about the IP packet, like origin, destination, length and packet number. IP packet comprises data or payload. Payload may comprise audio-, video-, image-, text-, document-, awareness-, environmental awareness data or any combination of such or alike. Payload may be encrypted before transmission to a network. IP packet may comprise a trailer, which indicates end of the packet and possible error detection and correction information for the data packet.

Communication, like a voice data, received from a communication network, is received by a communication device 101. The communication device 101 is arranged to pass incoming communication to the dedicated device A. The dedicated device A is arranged to receive encrypted (stream of) information and decrypt it for the communication device 101. After decrypted, the communication device 101 that received the information from the network, is able to reproduce it for a user. The decrypted information may be presented at the communication device 101. For example audio data may be produced via loudspeaker of the communication device 101, image or text data may be presented via display of the communication device 101, video data may be produced via both loudspeaker and display of the communication device 101.

The communication device 101 is arranged to transmit encrypted speech data to the communication device 102 in a communication network. Data received from a communication network to the communication device 102 is decrypted by the dedicated device B, correspondingly. Communication device 102 receiving the encrypted speech data is arranged to transmit the encrypted speech data to the dedicated device B via a communication link 104. The dedicated device B is arranged to decrypt payload received from the network. If the communication device 102 is arranged to transmit a speech data, it is transmitted to the dedicated device B for encryption before transmission to the network.

Transmission via network, for example between the communication device 101 and the communication device 102, may comprise an unsecure connection between the communication devices 101, 102. Devices 101, 102 may be unverified, non-verifiable and/or untrusted. The encrypted data provides security for the payload or information, which is delivered to the devices and/or transmitted via the network.

The dedicated device A is arranged to encrypt incoming communication, as inputted by a user of the communication device 101, for transmission via the communication device 101. At the same time the dedicated device A is arranged to receive encrypted (stream of) data from communication device 102 of the network, which is connected via the network with the communication device 101. The connection may be an established voice connection. The dedicated device B is arranged to receive data via connection 104 from the communication device 102. The dedicated device B is arranged to encrypt speech of a user of the communication device 102, before the encrypted data is transmitted from the communication device 102 via the network to the communication device 101. The dedicated device A is arranged to receive encrypted (stream of) data via the communication device 101 and to decrypt it for reproduction and/or for presentation for a user of the communication device 101.

The dedicated device(s) may have effect of enabling simultaneous, continuous and/or full duplex voice communication. For example during a voice connection, like a call, continuous voice data is encrypted by a dedicated device before sending to other communication device via network, and simultaneously encrypted voice data, received via the network from the other communication device, is decrypted. The dedicated device(s) may utilize one or multiple network access nodes for delivering encrypted payload through the access node or multiple access nodes to/from the communication devices. Network access node may comprise network access device, network communication point or alike. The dedicated device(s) may deliver encrypted payload through multiple parallel access nodes simultaneously to one/more communicating network devices. The dedicated device may comprise different kind of communication blocks for simultaneous communication. For example, sending and receiving may be established via different routes or paths or means of communication at a dedicating device.

Apparatus according to an embodiment comprises at least a dedicated device and optionally a communication apparatus. FIG. 2 illustrates an apparatus according to an embodiment comprising two dedicated devices 205, 206 and two communication apparatus 201, 202. A communication apparatus 201 comprises transceiver branch. Transceiver branch comprises an antenna and receiver/transmitter. Transceiver is able to receive and transmit data and/or signaling in a communication network via the antenna for connecting to a network via a radio link. Via antenna incoming radio waves are provided to a receiver branch and outgoing signals/data are provided to the antenna via transmitter branch. The receiver/transmitter branches may comprise decoder-encoder, modulator-demodulator and/or digital-to-analog (D/A)- and analog-to-digital (A/D) converters. The receiver-transmitter branch is arranged to receive and transmit data and/or signaling to and from a radio network via the antenna. The apparatus 201 may comprise a subscriber identity module SIM of an operator of the cellular network, which allows the transceiver to be an identifiable and contactable via network.

The apparatus 201 further comprises a memory MEM, a microprocessor Proc, and a controller Ctrl, as illustrated in the FIG. 2. The apparatus 201 may comprise other blocks, like a loudspeaker arranged to implement voice/sound output, or a microphone arranged to implement voice/sound input, or a display arranged to display information. A display, like a touch screen, may provide visual output as well as input means. There may be other blocks, units or functions, or some of the illustrated blocks may be left out or replaced with other block of similar or different function. The apparatus 201 comprises a connector arranged to provide access to a dedicated device 205.

The dedicated device 205 comprises a processor for example a microprocessor, for executing software and/or executable instructions. The dedicated device 205 comprises a memory MEM for storing executable instructions and the processor for executing the instructions. The dedicated device may comprise a random access memory RAM. Programs, algorithms and source code for encryption are saved in the memory MEM. The instructions for processing speech data may be stored in the memory MEM. The processing instructions may be executed by the processor of the dedicated device 205. The processing may comprise encryption or decryption. Audio data received from the network is decrypted and audio data is encrypted before sent to a network or to another network entity or device.

The two communicating apparatuses 201, 202 may be similar or of a different kind. In the FIG. 2 apparatus 202 comprises a transmission branch comprising antenna a receiver and a transceiver for sending data to and receiving data from a communication network. Apparatus 202 comprises SIM for identification in the network. Apparatus 202 comprises means for providing access or a link 204 to a dedicated device 206. The dedicated device comprises a processor and memory MEM, as well as a random access memory RAM. Processor may encrypt speech data received from the apparatus 202 according to encryption algorithm stored in the memory MEM. Processor may decrypt encrypted speech data (payload) received from communication network according to decryption algorithm stored in the memory MEM.

According to embodiments user interface and controlling of a communication device remain separated from the dedicated encryption device. Even if a communication device is compromised, lost or forensically examined, encryption device according to embodiments is not affected.

The dedicated device comprises a processor for executing program code, a memory for storing a program code and connector for establishing a connection to a device, like a communication device of a network. The connector may comprise physical cable connection or alike wired connection, a Bluetooth transceiver, an infrared transceiver, an optical transceiver, or alike wireless transceiver which may be arranged to establish a wireless connection. In an embodiment, the dedicated device may be physically attached or integrated to a communication device via cable, casing or other fixed means. The dedicated device according to embodiments comprises separated parts, not shared with the communication device. Such unshared parts are for example memory and/or logical memory space and/or blocks participating to implementing communication over network, for example networking interface stack, Transmission Control Protocol/Internet Protocol, TCP/IP.

TCP/IP is used as a communication protocol in network. TCP/IP comprises two-layer program, wherein the higher layer, TPC, manages assembling of information or data into smaller packets, which are transmittable over network. Receiving TCP layer reassembles packets into their original form. IP handles address part of each packet in order to get it to the right destination. Gateway nodes on the network check addresses in order to forward the packet(s) to correct destination. Some packets may be routed differently compared to other ones, but all received packets will be reassembled at the destination.

Dedicated device according to an embodiment may be used together with transmission equipment. The dedicated device may be connected to a mobile terminal, fixed computing equipment, like laptop, or directly to transmission element(s) of a network access, like to a wireless router, like WiFi, optical field or radio interconnection.

Transmitted, encrypted, payload may comprise any kind data, like speech-, video-, data-, image-, document-, information-, stream type or any combination of these.

Dedicated device may be used in a standalone mode, where all communication transmission is handled by the dedicated device itself. Even if used in a standalone mode, no memory, control processing unit or parts of the dedicated device are connected to, nor interact with network transmission part relating elements of the dedicated device. A dedicated device according to an embodiment does not create any log file, nor does it store any communication log. When user interface is handled by mobile phone, to which the dedicated device is attached to or communicating with, user interface components are not run on the dedicated device. Instead components relating to user interface are generated in the dedicated device and displayed on mobile phone or terminal display only—not on a dedicated device. This provides effect of remaining encryption means secret, even in the event of investigation or compromising of a user terminal. Presence or history data or usage of any encryption means is not revealed via terminal. The dedicated device is arranged to hold, generate and present user interface through a terminal without any user interface code run on terminal.

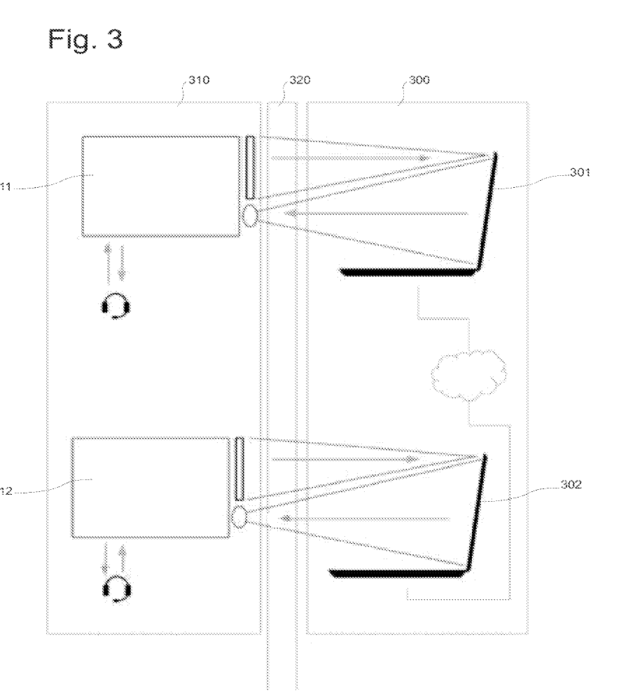

FIG. 3 illustrates a system according to an embodiment. The system of FIG. 3 comprises an untrusted binary and communication domain 300. The domain 300 comprises a laptop 301, another laptop 302 and a communication network via which the laptops 301, 302 may communicate and exchange information. Communication network may be an internet, an intranet, an extranet or alike communication network. FIG. 3 comprises a trusted domain 310 comprising trusted device 311 and another trusted device 312. The trusted devices 311, 312 comprise a source code comprising no binary components/elements, and a processor arranged to execute an executable code converted solely from a source code only and comprising no additional binary elements. The trusted domain 310 and the untrusted domain 300 have been connected via optical interface 320. For example a laptop 301 is able to connect to a dedicated device 311 via optical interface 320 and a laptop 302 is able to connect to a dedicated device 312 via optical interface 320. The dedicated device 311, 312 comprises an optical presentation layer and an optical reader. Optical presentation layer may comprise a binary display module. Optical reader may comprise a camera or a display decoder. Encrypted transmission unit, as encrypted by a dedicated device 311, may be modulated to optical representation. Optical representation on the dedicated device 311 may be detected, for example red, by the laptop 301. The laptop 301 may then transmit the encrypted transmission unit to the network.

Encrypted transmission unit received by a laptop 302 may be presented in the display of the laptop 302. The dedicated device 312 may read the demodulated received transmission from the laptop 302 display. The dedicated device 312 may comprise camera for detecting information form the laptop 302 display via optical interface 320. For example, the laptop 301, 302 is used for transmitting data in communication network and arranged to run commercial operating system and closed source video conferencing application. The dedicated device 311 is placed in view of the transmission laptop 301, and correspondingly the dedicated device 312 is placed in view of the transmission laptop 302. The dedicated device 311 (312) is arranged in optical, visual connection with the laptop 301 (302) display. The dedicated device 311 (312) is able to see via its camera the data stream and receive the data stream via camera from the laptop 301 (302) display. The dedicated device 311 (312) is able to display data stream (handled by the dedicated device 311 (312) providing it available for the camera of the laptop 301 (302). Thus the laptop 301 (302) is arranged to exchange information with the dedicated device 311 (312) correspondingly, via optical interface 320.

The optical interface 320 has effect of allowing transmission between the trusted and untrusted domains without any electrical means or IP protocols. The laptops 301, 302 may send and receive data stream over insecure videoconferencing connection. The content of the data stream may be secured using dedicated devices for encryption/decryption. This has effect of providing secure communication even via unsecure network channel or link.

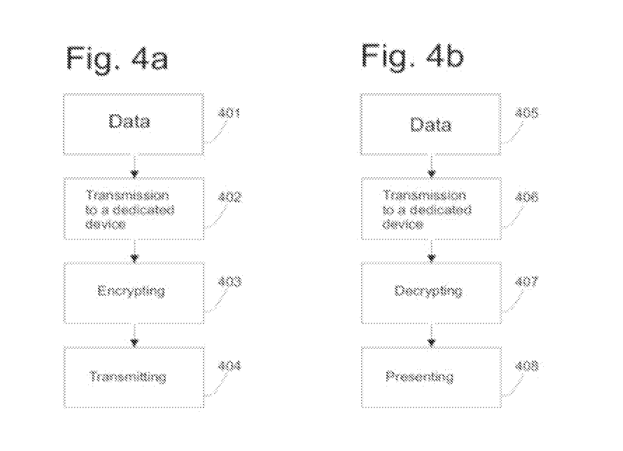

FIG. 4a illustrates a method according to an embodiment. Data is received or created in phase 401. Data may comprise a single transmitted data unit or data stream or other form. Data may be inputted by a user of a device. Data comprising speech data may be processed, which may comprise audio-digital conversion, digitizing, compression. Data may be processed in order to form a data packet, which comprises payload and which may be delivered over a communication network. Data payload is transmitted to a dedicated device in phase 402. Data payload may be transmitted via a wired connection or a wireless connection, for example optically, via Bluetooth, Wifi or cable connection. In the dedicated device payload is encrypted in the phase 403. Encrypted payload is transmitted in phase 404 to communication network, like air interface, internet, radio link.

FIG. 4b illustrates a method according to embodiments. In a receiving end received data 405, which comprises encrypted payload, like audio stream, is transmitted to a dedicated device 406. Data may be transmitted to the dedicated device via a wired connection or a wireless connection, for example Bluetooth connection. In the dedicated device payload of the received encrypted data is decrypted in the phase 407. Decrypted payload or data stream is reproduced or presented 408 in the receiving end. Decrypted data is presented by a receiving device, for example audio stream/payload may be reproduced by a loudspeaker and/or image/video stream/payload may be presented by a display.

A network entity may establish communication to another entity via the network(s). Communication may comprise continuous two-way communication, like voice calls. Communication may comprise point to multipoint type of communication, point-to-point type of communication, or one-way communication, for example.

According to an embodiment communication comprises transferring data payload from a point to a point or to multiple points. As illustrated in the previous with the audio payload, data stream, data packet or other transmission unit may comprise other kind of payload, for example video, audio, text, image, document or combination of such. Any kind of payload may be encrypted/decrypted using a dedicated device according to an embodiment. A dedicated device comprises random number generator. The dedicated device includes a true random number generator. This enables ensuring entropy for randomness.

Communication network may comprise a cellular network, a radio link, an internal- or a local area network. A cellular network may comprise Global System for Mobile Communications (GSM), Fourth Generation of mobile telecommunications technology (4G), Long Term Evolution (LTE) or alike previous or further generation of mobile telecommunication technology. Alternatively or in addition, communication may include or be established via short range wireless connection, like infrared (IR), Bluetooth and/or WiFi (Institute of Electrical and Electronics Engineers, IEEE 802.11 standards). Communication network may comprise a dedicated non-centralized mesh network. Network may provide ability to connect via one or more same, similar, different or different type of networks.

A terminal may comprise a network entity, a mobile device, a mobile station, a smart phone, a virtual gateway operator, a computer.

A terminal may comprise an address or an identity module, a transceiver and ability to communicate over the network, i.e. transmit and receive calls and audio data/signals.

A terminal is able to connect to a dedicated device according to embodiments. Data arranged to be transmitted in a communication network via the terminal is arranged to be transmitted between the terminal and a dedicated device. The dedicated device is arranged to encrypt the data before transmission to a network and decrypt the data received from the network. A connection may be provided ad hoc between a mobile terminal and a dedicated network. Ad hoc refers to connection provided for this specific task. The connection may not be adapted for other purpose, nor be generalizable. Ad hoc is kind of decentralized wireless connection provided as needed. At times when no ad hoc connection is established or available, there are no traces of used encryption in the mobile terminal.

Executable code for encryption is solely converted from a source code, which is lacking any binary elements or any pointers or any links to such. The source code lacks any binary elements. A source code without binary elements provides effect of enabling verifying source code for encryption. This enables possibility to change, upgrade, double-check and verify elements, levels and operation. Source code visibility may provide possibility to ensure encryption level(s) and operation.

A dedicated hardware and a source code lacking of any binary modules/elements provide effect of enabling immunity to attack vectors built on binary deliverable mobile operating systems or network transmission elements in communication networks. Dedicated hardware includes a random number generator. This enables making sure that entropy for randomness is guaranteed.

Communication between a dedicated device and communicating device(s) may be arranged via multiple communication links. Communication may be arranged via parallel communication links. For example an encrypted communication may be delivered via several communication devices, as multipath transmission. Communication between the dedicated device and communication device(s) may comprise asymmetric transmission paths and/or full duplex communication. A dedicated device may comprise several routes, blocks, interfaces, means and/or connections for sending and for receiving. Communication may comprise sending and receiving via different routes, means and/or connections in a dedicated device. For example, encrypted speech data may be transmitted via WiFi connection, while received encrypted speech data may be received via optical connection interface.

According to an embodiment a method for encrypting a communication data of a communication device comprises establishing a connection to a dedicated device and transmitting the communication data via the connection to the dedicated device. The method further comprises encrypting the communication data by executing program code stored in a memory of the dedicated device by a processor of the dedicated device. The method may comprise any one or more of the following:

A method, wherein the connection to the dedicated device is provided ad hoc. The connection is available based on need or user request, for example. The connection is provided for data transmission. When the connection is not active, there are no traces of used encryption method in the communication device.

A method may comprise the connection to the dedicated device comprising a wired connection, a cable connection an optical interface, a Bluetooth connection, a Wifi connection.

A method may comprise the communication data comprising payload, comprising at least one or more of audio-, video-, text-, image data. Method may comprise encrypting payload(s) on a dedicated device, where payload(s) comprise any one or any combination of speech, imaginery document data, video stream(s), environmental awareness.

A method may comprise the program code comprising executable program code converted solely from a source code without binary elements. The source code comprises no binary elements/components.

A method may comprise executing the program code by the processor is implemented solely in the domain of the dedicated device, optionally without sharing any memory elements, memory space, network transmission relating elements with the communication device.

A method may comprise transmitting the encrypted communication data to a communication network via the communication device.

A method may comprise transmitting the encrypted communication data simultaneously via multiple communication nodes to/from the dedicated device.

According to another embodiment a method for decrypting a communication data of a communication device comprises receiving encrypted communication data, establishing a connection to a dedicated device and transmitting the encrypted communication data via the connection to the dedicated device. The method further comprises decrypting the encrypted communication data by executing program code stored in a memory of the dedicated device by a processor of the dedicated device. The method may comprise any one or more of the following:

A method, wherein the connection to the dedicated device is provided ad hoc. The connection is established when needed, for example requested by a user or triggered by a received encrypted data or established call connection or alike.

A method may comprise the connection to the dedicated device comprising wired connection, a cable connection an optical interface, a Bluetooth connection, a Wifi connection.

A method may comprise the encrypted communication data comprising payload, comprising at least one or more of audio-, video-, text-, image data. Method may comprise encrypting payload(s) on a dedicated device, where payload(s) comprise any one or any combination of speech, imaginery document data, video stream(s), environmental awareness.

A method may comprise the program code comprising executable program code converted solely from a source code without binary elements. The source code lacks any binary elements.

A method may comprise executing the program code by the processor implemented solely in the domain of the dedicated device, optionally without sharing any memory elements, memory space, network transmission relating elements with the communication device.

A method may comprise transmitting the decrypted communication data to the communication device and/or presenting the decrypted communication data at the communication device.

A method may comprise transmitting the decrypted communication data and/or receiving the decrypted communication data via multiple communication nodes from the dedicated device.

According to an embodiment a communication device for a communication network comprises a transceiver arranged to transmit communication data to the communication network and an interface arranged to establish a connection to a dedicated device in order to enable transmission of the communication data via the connection to/from the dedicated device. The dedicated device comprises a processor and a memory for storing a program code executable by the processor. The program code, when executed by the processor, is arranged to encrypt the communication data. The communication device may further comprise any one or more of the following:

A communication device, wherein the interface arranged to establish a connection to the dedicated device is provided ad hoc.

A communication device, wherein the interface comprises a wired interface plug, a cable plug, an optical interface, a Bluetooth interface, a WiFi interface; and/or wherein the connection to the dedicated device comprises a wired connection, a cable connection, an optical interface, a Bluetooth connection, a Wifi connection.

A communication device, wherein the communication data comprises payload, comprising at least one or more of audio-, video-, text-, image data.

Method may comprise decrypting encrypted payload(s) on a dedicated device, where payload(s) comprise any one or any combination of speech, imaginery document data, video stream(s), environmental awareness.

A communication device, wherein the program code comprises executable program code converted solely from a source code, which source code comprises no binary elements.

A communication device, wherein the program code and the processor are placed solely in the domain of the dedicated device. Optionally the program code and the processor are placed solely in the domain of the dedicated device without sharing any memory elements, memory space, network transmission relating elements with the communication device.

A communication device may comprise a transceiver arranged to transmit the encrypted communication data to the communication network via the communication device.

A communication device, wherein the connection may be arranged for transmitting encrypted data via multiple communication nodes.

According to an embodiment a communication device for a communication network comprises a transceiver arranged to receive encrypted communication data from the network and an interface arranged to establish a connection to a dedicated device in order to enable transmission of the encrypted communication data via the connection to/from the dedicated device. The dedicated device comprises a processor and a memory for storing a program code executable by the processor. The program code, when executed by the processor, is arranged to decrypt the encrypted communication data. The communication device may comprise any one or more of the following:

A communication device, wherein the connection to the dedicated device is provided ad hoc.

A communication device, wherein the interface comprises a wired interface plug, a cable plug, an optical interface, a Bluetooth interface, a WiFi interface.

A communication device, wherein the encrypted communication data comprises payload, comprising at least one or more of audio-, video-, text-, image data. Method may comprise decrypting encrypted payload(s) on a dedicated device, where payload(s) comprise any one or any combination of speech, imaginery document data, video stream(s), environmental awareness.

A communication device, wherein the program code comprises executable program code converted solely from a source code, which source code comprises no binary elements.

A communication device, wherein the program code and the processor are placed solely in the domain of the dedicated device, optionally without sharing any memory elements, memory space, network transmission relating elements with the communication device.

A communication device comprising a transceiver arranged to transmit the decrypted communication data to the communication device and a communication device arranged to present the decrypted communication data.

A communication device, arranged to receive encrypted communication data via multiple communication nodes.

According to an embodiment a dedicated device comprises an interface arranged to establish a connection to a communication device of a network, a processor, a program code. The program code, when executed by the processor arranged to encrypt/decrypt a communication payload received via the interface. The dedicated device may comprise any one or more of the following:

A dedicated device, wherein the interface comprises a wired interface plug, a cable plug, an optical interface, a Bluetooth interface, a WiFi interface.

A dedicated device, wherein the communication payload comprises at least one or more of audio-, video-, text-, image data.

A dedicated device, wherein the program code comprises executable program code converted solely from the source code without binary elements. The source code lacks any binary elements/components or pointers to such.

A dedicated device, wherein the program code and the processor are placed solely in the domain of the dedicated device.

A dedicated device, wherein the program code and the processor are placed solely in the domain of the dedicated device, without sharing any memory elements, memory space, network transmission relating elements via the interface.

According to yet another aspect a system for arranging communication between communication devices in communication network comprises two communication devices each comprising a transceiver arranged to transmit encrypted data to and receive encrypted data from the communication network. Each one of the communication devices is connectable to a dedicated device in order to enable transmission of decrypted/encrypted data between the connected communication device and dedicated device, wherein the dedicated device is arranged to encrypt/decrypt the decrypted/encrypted data. The system may comprise any one or any combination of the following:

A system, wherein connection between the communication device and the dedicated device is arranged ad hoc.

A system, wherein communication between the communication devices is arranged via multiple communication links, optionally parallel communication links.

A system, wherein the communication between the communication devices uses asymmetric transmission paths and/or full duplex communication.

A system, wherein the communication device is arranged to transmit encrypted data and receive encrypted data via different connections and/or routes and/or means.

What is claimed is:

1. A method for encrypting a communication data of a communication device, the method comprising
establishing a connection to a dedicated device,
transmitting the communication data via the connection to the dedicated device,
encrypting the communication data by executing program code stored in a memory of the dedicated device by a processor of the dedicated device.

2. The method according to claim 1, wherein the connection to the dedicated device is provided ad hoc.

3. The method according to claim 1, wherein the connection to the dedicated device comprises a wired connection, a cable connection an optical interface, a Bluetooth connection, a Wifi connection.

4. The method according to claim 1, wherein the communication data comprises payload, optionally comprising at least one or more of audio-, video-, text-, image-, document-, environmental awareness data.

5. The method according to claim 1, wherein the program code comprises executable program code converted solely from a source code, which lacks any binary elements.

6. The method according to claim 1, wherein executing the program code by the processor is implemented solely in the domain of the dedicated device, optionally without sharing any memory elements, memory space, network transmission relating elements with the communication device.

7. The method according to claim 1, comprising transmitting the encrypted communication data to a communication network via the communication device.

8. The method according to claim 1, comprising transmitting the encrypted communication data via multiple communication nodes to/from the dedicated device.

9. A method for decrypting a communication data of a communication device, the method comprising
receiving encrypted communication data,
establishing a connection to a dedicated device,
transmitting the encrypted communication data via the connection to the dedicated device
decrypting the encrypted communication data by executing program code stored in a memory of the dedicated device by a processor of the dedicated device.

10. The method according to claim 9, wherein the connection to the dedicated device is provided ad hoc.

11. The method according to claim 9, wherein the connection to the dedicated device comprises wired connection, a cable connection an optical interface, a Bluetooth connection, a Wifi connection.

12. The method according to claim 9, wherein the encrypted communication data comprises payload, comprising at least one or more of audio-, video-, text-, image-, speech-, document-, environmental awareness data.

13. The method according to claim 9, wherein the program code comprises executable program code converted solely from a source code, which lacks any binary elements.

14. The method according to claim 9, comprising executing the program code by the processor solely in the domain of the dedicated device, optionally without sharing any memory elements, memory space and/or network transmission relating elements with the communication device.

15. The method according to claim 9, comprising transmitting the decrypted communication data to the communication device and/or presenting the decrypted communication data at the communication device.

16. The method according to claim 9, comprising transmitting the decrypted communication data and/or receiving the encrypted communication data via multiple communication nodes from the dedicated device.

17. A communication device for a communication network comprising
a transceiver arranged to transmit communication data to the communication network,
an interface arranged to establish a connection to a dedicated device in order to enable transmission of the communication data via the connection to/from the dedicated device,
wherein the dedicated device comprises a processor and a memory for storing a program code executable by the processor, and
wherein the program code, when executed by the processor, is arranged to encrypt the communication data.

18. The communication device according to claim 17, wherein the connection to the dedicated device is provided ad hoc.

19. The communication device according to claim 17, wherein the interface comprises a wired interface plug, a cable plug, an optical interface, a Bluetooth interface, a WiFi interface; and/or wherein the connection to the dedicated device comprises a wired connection, a cable connection, an optical interface, a Bluetooth connection, a Wifi connection.

20. The communication device according to claim 17, wherein the communication data comprises payload, which comprises at least one or more of audio-, video-, text-, image-, speech-, document-, awareness-data.

21. The communication device according to claim 17, wherein the program code comprises executable program code converted solely from a source code, which source code lacks any binary elements.

22. The communication device according to claim 17, wherein the program code and the processor are placed solely in the domain of the dedicated device, optionally without sharing any memory elements, memory space, network transmission relating elements with the communication device.

23. The communication device according to claim 17, wherein the transceiver is arranged to transmit the encrypted communication data to the communication network via the communication device.

24. The communication device according to claim 17, wherein the connection is arranged for transmitting encrypted data via multiple communication nodes.

25. A communication device for a communication network comprising
a transceiver arranged to receive encrypted communication data from the network,
an interface arranged to establish a connection to a dedicated device in order to enable transmission of the encrypted communication data via the connection to/from the dedicated device,
wherein the dedicated device comprises a processor and a memory for storing a program code executable by the processor, and
wherein the program code, when executed by the processor, is arranged to decrypt the encrypted communication data.

26. The communication device according to claim 25, wherein the connection to the dedicated device is provided ad hoc.

27. The communication device according to claim 25, wherein the interface comprises a wired interface plug, a cable plug, an optical interface, a Bluetooth interface, a WiFi interface.

28. The communication device according to claim 25, wherein the encrypted communication data comprises payload comprising at least one or more of audio-, video-, text-, image data.

29. The communication device according to claim 25, wherein the program code comprises executable program code converted solely from a source code, where the source code consists of source code without binary elements.

30. The communication device according to claim 25, wherein the program code and the processor are placed solely in the domain of the dedicated device, optionally without sharing any memory elements, memory space, network transmission relating elements with the communication device.

31. The communication device according to according to claim 25, wherein the interface is arranged to transmit the decrypted communication data to the communication device, and the communication device is arranged to present the decrypted communication data.

32. The communication device according to according to claim 25, wherein the communication device is arranged to receive encrypted communication data via multiple communication nodes.

33. A dedicated device comprising
an interface arranged to establish a connection to a communication device of a network,
a processor,
a program code,
the program code, when executed by the processor arranged to encrypt/decrypt a communication payload received via the interface.

34. The dedicated device according to claim 33, wherein the interface comprises a wired interface plug, a cable plug, an optical interface, a Bluetooth interface, a WiFi interface.

35. The dedicated device according to claim 33, wherein the communication payload comprises at least one or more of audio-, video-, text-, image-, document-, awareness-, speech data.

36. The dedicated device according to claim 33, wherein the program code comprises executable program code converted solely from a source code, where the source code consist of source code without binary elements.

37. The dedicated device according to claim 33, wherein the program code and the processor are placed solely in the domain of the dedicated device.

38. The dedicated device according to claim 33, wherein the program code and the processor are placed solely in the domain of the dedicated device, without sharing any memory elements, memory space, network transmission relating elements via the interface.

39. A system for arranging communication between communication devices in communication network comprising
two communication devices each comprising a transceiver arranged to transmit encrypted data to and receive encrypted data via the communication network,
each one of the communication device is connectable to a dedicated device in order to enable transmission of decrypted/encrypted data between the connected communication device and dedicated device, wherein the dedicated device is arranged to encrypt/decrypt the decrypted/encrypted data.

40. The system according to claim 39, wherein connection between the communication device and the dedicated device is arranged ad hoc.

41. The system according to claim 39, wherein communication between the dedicated device and the communication devices is arranged via multiple communication links, optionally parallel communication links.

42. The system according to claim 39, wherein the communication between the dedicated device(s) and the communication devices uses asymmetric transmission paths and/or full duplex communication.

43. The system according to claim 39, wherein the dedicated device is arranged to transmit encrypted data and receive encrypted data via different connections and/or routes and/or means.
